(19) United States
(12) Patent Application Publication
(10) Pub. No.: US 2015/0094911 A1
(43) Pub. Date: Apr. 2, 2015

(54) DEVICE AND METHOD FOR DETERMINING THE DRIVING STATE OF A VEHICLE

(71) Applicant: Pascal Munnix, Berg (DE)

(72) Inventor: Pascal Munnix, Berg (DE)

(21) Appl. No.: 14/381,006

(22) PCT Filed: Mar. 2, 2012
(86) PCT No.: PCT/EP2012/000941

§ 371 Date: Dec. 4, 2014

(30) Foreign Application Priority Data
Mar. 2, 2012 (WO) PCTEP2012000941

(51) Int. Cl. G07C 5/02; G05D 1/02

(52) U.S. Cl. CPC G07C 5/02; G05D 1/021
USPC 701/41; 701/1; 701/70

(57) ABSTRACT

A method for determining the driving state of a vehicle comprises the following steps:
detecting (21) first measurement signals of a first inertial measurement sensor system (1, 100), wherein the first inertial measurement sensor system is arranged in a first region of the vehicle so that it does not execute a relative movement in relation to the first region of the vehicle, and wherein the first measurement signals correspond to at least one acceleration component in three-dimensional space and/or at least one rotation rate component of the first inertial measurement sensor system (1, 100) in the first region of the vehicle in three-dimensional space;
detecting (21) second measurement signals of a second inertial measurement sensor system (2, 100), wherein the second inertial measurement sensor system is arranged in a second region of the vehicle, which is movable in relation to the first region of the vehicle, wherein it is arranged so that it does not execute a relative movement in relation to the second region of the vehicle, and wherein the second measurement signals correspond to at least one acceleration component in three-dimensional space and/or at least one rotation rate component of the second inertial measurement system (2, 100) in the second region of the vehicle in three-dimensional space;
analyzing (22, 23, 24, 25) the first and second measurement signals based on the functional relationship between the movement of the first inertial measurement system and the movement of the second inertial measurement sensor system; and
based on the result of the analysis of the first and second measurement signals, determining (26) the relative orientation of the two inertial measurement sensor systems to one another.

### FIELD OF THE INVENTION

The invention relates in general to devices and methods for detecting the driving state of a vehicle and in particular a method, an installation kit or a retrofitting installation kit, and a vehicle control system for determining the driving state of a vehicle.

### BACKGROUND OF THE INVENTION

One important problem of vehicle dynamics control systems and motor vehicle safety systems is to stabilize the vehicle in critical situations, for example, when it begins to skid. The first systems introduced in mass production for solving this problem were antilock braking systems (ABS) and traction control systems (TCS), which primarily act on the longitudinal-dynamic behavior of the motor vehicle. As a fundamental development, vehicle dynamics control systems were developed, which also influence the behavior of the vehicle in a stabilizing manner in transverse-dynamics critical situations by controlled measures such as the active braking of individual wheels, control of the drive torque to implement slip on the wheels, and/or by active steering. Such systems are, for example, the electronic stability program (ESP) or the active front steering (AFS) for controlled steering intervention from BMW.

All vehicle dynamics control systems share the feature that they must firstly ascertain the driving state of the vehicle as precisely as possible, for which, inter alia, movement sensors are required. The more these movement variables and driving state parameters are known, the better and more reliably can the driving state be ascertained in principle and the more effectively and safely can undesired behavior of the vehicle be counteracted. For example, the plausibility of the ascertained driving state can be checked by way of additional known movement variables. In addition, in extraordinary driving situations, for example, in extremely steep curves, it can possibly no longer be possible without the use of such further movement variables to ensure control and therefore stabilization of the vehicle. For this purpose, however, further movement sensors are generally necessary, which increase the costs of a vehicle dynamics control system or safety system. Because of this, producers of such systems fundamentally attempt to keep the number of required sensor elements as low as possible, particularly because it sometimes appears necessary, at least for the most important movement sensors, to design them redundantly for safety reasons, so that two sensor elements must be installed for measuring each further movement variable, with the correspondingly increased costs.

Determining the driving state on the basis of models, such as observers, tire models, etc., is known. For example, a device and a method are disclosed in DE 10 2007 047 337 A1, in which the transverse velocity of the vehicle is ascertained from the measurement of the transverse acceleration while using a tire model. By adding correction variables, for example, the vehicle longitudinal velocity and the yaw rate, the precision of the calculation of the transverse speed can be further improved. The yaw rate describes an angular velocity of the rotation of the vehicle about its vertical axis.

Furthermore, it is known that vehicle dynamics control systems require the wheel steering angle of the vehicle as an input variable for the control. The “wheel steering angle” is the angle between a front wheel and the vehicle longitudinal direction.

In general, the toothed rack stroke, i.e., a transverse movement of the toothed rack in the steering gear of a vehicle, or the steering gear pinion angle, i.e., the steering angle on the steering gear input, or the driving steering angle is measured. The driving steering angle is the rotational angle of the steering column, which is in turn identical to the pinion angle except for the steering column twisting due to steering torque or positioning intervention of an active steering to system.

The measured steering angle can be converted via a characteristic curve into the wheel steering angle.

It is possible to calculate, in simplified form, from wheel steering angle, driving velocity, and wheelbase how large the “setpoint yaw rate” should be during stable driving behavior. The vehicle stability is evaluated from a comparison of the calculated setpoint yaw rate to the measured actual yaw rate.

If the actual yaw rate is greater in absolute value than the setpoint yaw rate, this indicates oversteering. The vehicle control systems then take measures to reduce the actual yaw rate.

If the actual yaw rate is less in absolute value than the setpoint yaw rate, this indicates understeering. The vehicle control systems then take measures to increase the actual yaw rate or reduce the setpoint yaw rate, for example, by slowing the vehicle.

Because system malfunctions could result in driving situations that are difficult to control, the safety requirements placed on steering angle sensors are very high. On the one hand, the sensors are constructed so that measurement errors can be reliably recognized and, on the other hand, the steering angle values are transmitted by means of secured messages to the control unit, for example, via CAN or FlexRay.

Retrofitting a steering angle sensor is generally very complex. Current vehicles hardly have any space on the steering column to retrofit a steering angle sensor. Even if space is found, the restricted space on the steering column generally has the result that a very special solution must be developed for the affected vehicle. In addition, steering angle sensors generally cannot be transferred from one vehicle into another. For this reason, it is often complex and costly to retrofit ESP systems accordingly with a steering angle sensor.

Against this background, the object of the present invention is to provide an improved method, an improved installation kit, and an improved vehicle control system, which enable a determination of the vehicle state.

### SUMMARY OF THE INVENTION

According to a first aspect, the invention provides a method for determining the driving state of a vehicle, wherein the method comprises the following steps: detecting first measurement signals of a first inertial measurement sensor system, wherein the first inertial measurement sensor system is arranged in a first region of the vehicle so that it does not execute a relative movement in relation to the first region of the vehicle, and wherein the first measurement signals correspond to at least one acceleration component in three-dimensional space and/or at least one rotation rate component of the first inertial measurement sensor system in the first region of the vehicle in three-dimensional space; detecting second measurement signals of a second inertial measurement sensor system, wherein the second inertial measurement sensor system is arranged in a second region of the vehicle, which is movable in relation to the first region of the vehicle, wherein it is arranged so that it does not execute a relative movement in relation to the second region of the vehicle, and wherein the second measurement signals correspond to at least one acceleration component in three-dimensional space and/or at least one rotation rate component of the second inertial measurement sensor system in the second region of the vehicle in three-dimensional space; analyzing the first and second measurement signals based on the functional relationship between the movement of the first inertial measurement system and the movement of the second inertial measurement system; and based on the result of the analysis of the first and second measurement signals, determining the relative orientation of the two inertial measurement sensor systems to one another.

According to a second aspect, the invention provides an installation kit for a vehicle for determining a relative orientation between a first and a second region of the vehicle, which are movable in relation to one another, comprising: a first inertial measurement sensor system to be arranged in the first region of the vehicle, which is designed for the purpose of outputting first measurement signals, which correspond to at least one acceleration component in three-dimensional space and/or at least one rotation rate component of the first inertial measurement sensor system in the first region of the vehicle in three-dimensional space, wherein the first inertial measurement sensor system is attachable in the first region of the vehicle so that it does not execute a relative movement in relation to the first region of the vehicle, a second inertial measurement sensor system to be arranged in the second region of the vehicle, wherein the second region is movable in relation to the first, wherein the second inertial measurement sensor system is designed for the purpose of outputting second measurement signals, which correspond to at least one acceleration component in three-dimensional space and/or at least one rotation rate component of the second inertial measurement sensor system in the second region of the vehicle in three-dimensional space, wherein the second inertial measurement sensor system is attachable in the second region of the vehicle so that it does not execute a relative movement in relation to the second region of the vehicle; and an analysis unit, which analyzes the signals of the first and second inertial measurement sensor systems and determines a relative orientation between the first and the second inertial measurement sensor systems.

According to a third aspect, the present invention provides a vehicle control system, comprising: a first inertial measurement sensor system to be arranged in a first region of the vehicle, which is designed for the purpose of outputting first measurement signals, which correspond to at least one acceleration component in three-dimensional space and/or at least one rotation rate component of the first inertial measurement sensor system in the first region of the vehicle in three-dimensional space, wherein the first inertial measurement sensor system is attachable in the first region of the vehicle so that it does not execute a relative movement in relation to the first region of the vehicle; a second inertial to measurement sensor system to be arranged in a second region of the vehicle, wherein the second region is movable in relation to the first, wherein the second inertial measurement sensor system is designed for the purpose of outputting second measurement sensor signals, which correspond to at least one acceleration component in three-dimensional space and/or one rotation rate component of the second inertial measurement sensor system in the second region of the vehicle in three-dimensional space, wherein the second inertial measurement sensor system is attachable in the second region of the vehicle so that it does not execute a relative movement in relation to the second region of the vehicle; and a controller, which is designed for the purpose of analyzing the signals of the first and second inertial measurement sensor systems and determining a relative orientation between the first and the second inertial measurement sensor systems.

Further features and aspects of the invention results from the dependent claims, the following description of preferred embodiments, and the appended drawings.

### BRIEF DESCRIPTION OF THE DRAWINGS

The invention will be explained in greater detail on the basis of exemplary embodiments and the appended exemplary drawings. In the figures of the drawings:

FIG. 1 shows a schematic illustration of vehicle movement variables and inertial measurement systems in a vehicle;

FIG. 2 shows a flow chart of a method according to one embodiment;

FIG. 3 shows a schematic illustration of the components of a measurement sensor system according to one embodiment.

### DESCRIPTION OF THE EMBODIMENTS

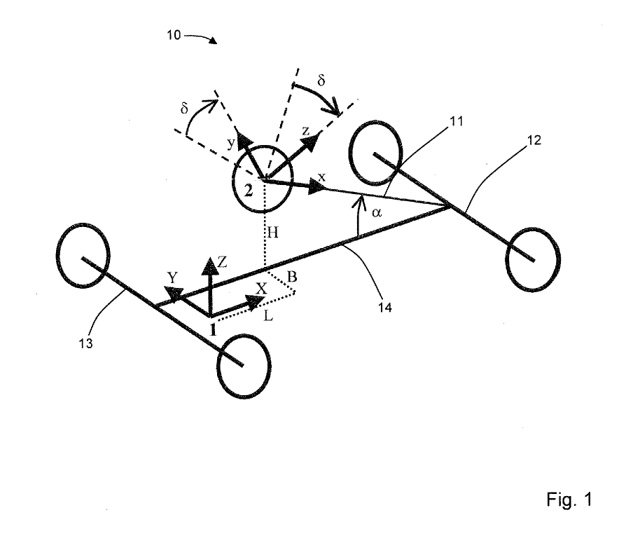

FIG. 1 illustrates the driving state of a vehicle.

Before a description in greater detail of FIG. 1, general explanations on the embodiments and the advantages thereof firstly follow.

For precise and high-performance function, vehicle dynamics control systems (also safety systems) require the most precise possible knowledge of the driving state of the vehicle. Important variables in this case are, for example, the vehicle longitudinal velocity (for wheel slip control of ABS, TCS, and ESP), the sideslip angle (for transverse dynamic control, for example, for the ESP), the roll angle (to avoid rollover), or the roadway slope (better TCS function).

As already mentioned at the outset, vehicle dynamics control systems typically require the wheel steering angle, i.e., the angle between a front wheel and the vehicle longitudinal direction, as an input variable for the control. In this case, the wheel steering angle is known to be determined by the measurement mentioned at the outset of the toothed rack stroke, the steering gear pinion angle, or the driver steering angle. The measured steering angle can be converted into the wheel steering angle via a characteristic curve.

System malfunctions can result in driving situations that are difficult to control and therefore the safety demands placed on the steering angle sensors are very high. Accordingly, the steering angle sensors are constructed so that measurement errors can be reliably recognized. In addition, in some embodiments, steering angle values can be transmitted by means of secured messages, for example, to a control unit in a vehicle (for example, via a CAN or FlexRay).

In particular older vehicles without ESP often do not have a steering angle sensor. However, retrofitting a steering angle sensor is generally very complex. Current vehicles hardly have any space on the steering column to retrofit a steering angle sensor. If a space has been found, the restricted space on the steering column typically requires that a very special solution must be developed for the affected vehicle. In addition, steering angle sensors generally cannot be transferred from one vehicle into another. For this reason, in some cases there is also no possibility of retrofitting ESP systems at acceptable costs.

The inventor has recognized that it is possible, for example, to determine the steering angle by way of two inertial measurement systems, which are attached at different positions in the vehicle. One inertial measurement system or one inertial measurement sensor system spans a three-dimensional inertial system in this case and can record measurement signals in the x, y, and z directions and thus can measure accelerations, rotation rates, or other movement variables in three-dimensional space. A first inertial measurement system is connected fixedly to the vehicle in this case at a first position and cannot execute a relative movement at the fastening position in relation to the vehicle. A second inertial measurement system is arranged at a second position of the vehicle so that it cannot execute a relative movement in relation to the second position of the vehicle. This second position is, for example, the steering wheel or the steering column. In other embodiments, however, the second position can also be in a trailer, for example, so that the angle between trailer and a tractor vehicle can be determined. If the first position of the vehicle now moves in relation to the second position or the second position (for example, trailer) moves in relation to the first position (for example, tractor vehicle), the two measurement sensor systems thus accordingly also move and the relative movement between them can be determined. A relative orientation, which can be described by one or more relative angles between the inertial measurement systems, can be determined from a data comparison of the measurement signals provided by the two inertial measurement systems. For example, the steering angle can then be determined therefrom.

Accordingly, in some embodiments, a method for determining the driving state of a vehicle comprises multiple steps, which are described hereafter. Vehicles are to be understood in some embodiments as all vehicles which are capable of locomotion on land, in water, and/or in the air, and not only motor vehicles.

First measurement signals are detected by a first inertial measurement sensor system. The first inertial measurement sensor system is (fixedly) arranged in a first region of the vehicle so that it does not execute a relative movement in relation to the vehicle or the first region of the vehicle. This first region can be located at any desired position in the vehicle in this case. In some embodiments, the measurement sensor system is attached, for example, screwed (fixedly) onto the vehicle body. The first measurement signals comprise in this case signals which correspond to at least one three-dimensional acceleration component and/or one three-dimensional rotation rate component of the first inertial measurement sensor system in the first region of the vehicle. The three-dimensional acceleration component (rotation rate component) corresponds in this case to a component of a three-dimensional acceleration (rotation rate) in a three-dimensional space, which is defined, for example, by the coordinate system (inertial system) of the first inertial measurement sensor system. In this case, in some embodiments, the three-dimensional acceleration (rotation rate) of the first measurement sensor system can be completely described in the three-dimensional coordinate system of the first measurement sensor system using three three-dimensional acceleration components (rotation rate components).

Since the first measurement sensor system is fixedly connected to the vehicle and does not execute a relative movement in relation to the vehicle or the first region of the vehicle, the measured acceleration components and rotation rate components also correspond to those of the vehicle or the first region of the vehicle, to which the first measurement sensor system is connected.

In some embodiments, a transformation of the acceleration values, which are output by the measurement sensor system, into the coordinate system of the vehicle is performed, or a transformation to a specific point of the vehicle is performed. The coordinate system can have its origin at the position where the measurement sensor system is also connected to the vehicle in this case, for example. The coordinate system can also be located at another position in the vehicle, however, for example, on the steering column.

This transformation is required in some embodiments, since the rotation rates which are determined using the measurement sensor system do exactly correspond to the rotation rate of the vehicle, but this is not the case for the acceleration values. For example, in the case of the centrifugal force, the acceleration value, i.e., in this case the centrifugal acceleration value, is dependent on the distance from the axis of rotation. Correspondingly, the acceleration value ascertained by the measurement sensor system is also dependent on how far the sensor is from an axis of rotation. In some embodiments, in which a high result precision or result quality is required, a conversion of the individual acceleration values (for example, three-dimensional acceleration values) to a specific (shared) point is accordingly necessary. This point can be located in this case in the measurement sensor system or in a corresponding region of the vehicle.

In addition, second measurement signals are detected by a second inertial measurement sensor system. The second inertial measurement sensor system is (fixedly) arranged in a second region of the vehicle, which is movable in relation to the first region of the vehicle. The second inertial measurement sensor system is attachable in this case in the second region so that it cannot execute a relative movement in relation to the second region. This second region is, for example, the steering column or the steering wheel of the vehicle. In other embodiments, the second region is, for example, a trailer and the first region is located in a tractor vehicle of the trailer. Furthermore, the second region can be arranged on a wheel of a vehicle.

The second measurement signals correspond to at least one three-dimensional acceleration component and/or at least one three-dimensional rotation rate component of the second inertial measurement sensor system in the second region of the vehicle, for example, the steering wheel, the steering column, the trailer, or the wheel, or the like. As stated above, the three-dimensional acceleration component (rotation rate component) corresponds in this case to a component of a three-dimensional acceleration (rotation rate) in a three-dimensional space, which is defined, for example, by the coordinate system (inertial system) of the second inertial measurement sensor system. In this case, in some embodiments, the three-dimensional acceleration (rotation rate) of the second measurement sensor system can be completely described in the three-dimensional coordinate system of the second measurement sensor system using three three-dimensional acceleration components (rotation rate components).

Because the first inertial measurement system is attachable in the first region and the second inertial measurement sensor system is attachable in the second region in each case so that they do not execute a relative movement in relation to the first or second region of the vehicle, respectively, the first and second inertial measurement sensor systems move in relation to one another precisely as the first and the second regions of the vehicle move in relation to one another.

In some embodiments, the first/second measurement signals correspond to one, two, or three acceleration and/or rotation rate components. In some embodiments, the first measurement signals correspond to the (complete) three-dimensional acceleration and/or the (complete) three-dimensional rotation rate of the first measurement sensor system in the first region of the vehicle and/or the second measurement signals correspond to the (complete) three-dimensional acceleration and/or the (complete) three-dimensional rotation rate of the second measurement sensor system in the second region of the vehicle.

Next, a relative orientation is determined between the first and second inertial measurement sensor systems and therefore also a relative orientation is determined between the first and second regions of the vehicle. The relative orientation can be described, for example, by one or more relative angles between the first and second measurement sensor systems or the inertial systems thereof. The relative angles are in this case, for example, the angles with which one inertial system can be rotated so that its x, y, and z axis is parallel to the x, y, or z axis, respectively, of the other inertial system. Correspondingly, in some embodiments, one, two, or more relative angles is/are ascertained for the description of the relative orientation.

For this purpose, firstly a functional relationship is determined between the movement of the first inertial measurement sensor system and the movement of the second inertial measurement sensor system. This functional relationship is determined once in some embodiments and is then predefined fixedly in a method sequence, for example, in which the current relative orientation is continuously determined.

On the basis of this determined functional relationship, the first and second measurement signals are analyzed and, on the basis of this analysis result, the relative orientation of the two inertial measurement sensor systems in relation to one another is determined.

From this relative orientation, in some embodiments, a relative angle, such as a wheel steering angle, or multiple relative angles, for example, wheel steering angle and inclination angle of a steering column, can be determined. In some embodiments, the wheel steering angle is determined from the relative angle via a vehicle-specific characteristic curve.

As mentioned, in both inertial measurement sensor systems, the movements of the associated regions of the vehicle are measured. Because each measurement sensor system has its own coordinate system or inertial system, in some embodiments, the determination of the functional relationship or the analysis of the first and second measurement signals comprises a transformation of the movement of the first inertial measurement sensor system or the first region in the first coordinate system of the first inertial measurement sensor system into the coordinate system of the second inertial measurement sensor system or into the movement of the second region of the vehicle in the coordinate system of the second inertial measurement sensor system.

In some embodiments, there are therefore multiple transformations. A first transformation, as stated above, in which the acceleration values of the (first) measurement sensor system are transformed on a specific (first) point, for example, on the vehicle, and a second transformation, during which, as just stated, the measurement signals of the (first) measurement sensor system are transformed into the coordinate system of the other (second) measurement sensor system.

In some embodiments, the corresponding movement equation systems are established for the first and the second inertial measurement sensor systems and, for example, solved on the basis of the respective measurement signals.

In some embodiments, the degrees of freedom of movement of the first and/or the second regions of the vehicle are ascertained. Together with the degrees of freedom of movement to be ascertained of the regions, a movement equation system is then established. This equation system is constructed as a filter in some embodiments. By solving the movement equation system based on the first and second measurement signals, for example, the relative angle of the two measurement sensor systems is obtained.

Because in some embodiments the first and/or second region only has restricted degrees of freedom of movement, as is the case in the steering column, for example, the movement equation system can be overdetermined.

In some embodiments, the integration is possible in a variety of vehicles in spite of standard construction, for example, due to very small dimensions. Furthermore, a signal of high quality—or at least sufficient quality—is provided, which simultaneously fulfills the above-mentioned high safety requirements.

In some embodiments, a vehicle velocity of the vehicle and a wheelbase of the vehicle are ascertained and, based on the wheel steering angle, the driving velocity, and the wheelbase, a setpoint yaw rate is determined.

In some embodiments, the predefined or determined setpoint yaw rate is compared to a measured actual yaw rate. Oversteering of the vehicle is determined if the actual yaw rate is greater in absolute value than the setpoint yaw rate. A vehicle control system can then engage accordingly, for example, to counteract the oversteer. Understeering is determined if the actual yaw rate is less in absolute value than the setpoint yaw rate. In this case, the vehicle control system counteracts the understeer accordingly.

In some embodiments, the second region of the vehicle only has one degree of freedom of movement in relation to the first region. The step of determining the relative orientation comprises in this case the analysis of a movement equation system, which is overdetermined, for example, and which is solved based on the first and second measurement signals. Due to the overdetermination of the movement equation system, at least two relative angle values can be determined redundantly and these can be compared to one another and/or can provide a higher precision of the relative angle value by averaging.

Because the steering column normally only has one degree of freedom in relation to the vehicle, but in some embodiments multiple movement equations can be established on the basis of the existing measurement signals of the first and second inertial measurement sensor systems, the movement equation system is overdetermined in such cases. The steering angle value can thus be ascertained from multiple movement equations and is therefore provided redundantly for the safety check.

In some embodiments, a safety check is performed as to whether or not the ascertained relative orientation is erroneous.

For example, if the individual movement equations of the overdetermined movement equation system do not provide the same result, in some embodiments this means that the measured values of the inertial measurement sensor systems are not compatible with one another and therefore are at least partially erroneous. Because the steering angle can be ascertained redundantly using this method, a very high signal reliability is achieved.

In other embodiments, to check the steering angle, all three orientation angles of the steering column are determined and it is then checked whether all angles lie in a valid range. For example, if the result of the calculation indicates a steering column oriented straight up, the result must then be discarded, because the design data of the vehicle establish that the steering column points at a defined angle downward toward the front axle of the vehicle. If the steering column is adjustable, a corresponding angle range is established, in which the steering column can point in the direction of the front axle.

In some embodiments, not only the ascertained relative angle or angles, but rather all measured variables which have been provided by the rotation rate and/or acceleration sensors, are discarded. In some embodiments, the measured variables (measurement signals) and/or the relative angle or angles are used for a control system for the vehicle as input variables. If erroneous relative angles or measured variables are used for the control of the vehicle, this could result in flawed control and therefore driving instability of the vehicle, which is to be avoided.

In some embodiments, precisely a sufficient number of equations are used for determining the orientation, i.e., the equation system is not overdetermined. On the basis of the ascertained orientation, the measurement signals or measured values from one measurement sensor system (for example, the second) are then transformed into the coordinate system of the other measurement sensor system (for example, the first) (or vice versa), and it is then checked whether the measurement signals correspond. If significant deviations are recognized, the measurement signals and the relative angles ascertained therefrom are discarded, so that the erroneous values, as noted, do not result in errors during the control of the vehicle.

In some embodiments, to check ascertained relative angles or to check whether measurement errors exist, an arbitrary number of equations is established or all are used to transform the measurement signals from one coordinate system to the other and to compare the measurement signals to one another. The result, i.e., the measurement signals, are thus checked with respect to their quality in such embodiments in that all measurement signals of one sensor system—having the ascertained relative orientation—are transformed into the coordinate system of the other sensor system. If the method has worked correctly, there is correspondence of all measured values. If there are significant deviations, an error then exists, which results in corresponding measures, for example, discarding of the measured values.

In some embodiments, for example, if the first and second measurement sensor systems are arranged in a fixed orientation in relation to one another, the relative orientation between the two inertial measurement sensor systems in relation to one another is only determined once. If it is known once, the first measurement signals can be converted into the coordinate system of the second measurement sensor system and the first and second measurement signals can be compared to one another, without the relative angle having to be determined in the case of each set of new measurement signals. For example, if the first and second measurement signals then do not correspond (within certain limits), the measurement signals and/or the associated relative angle are thus discarded.

In some embodiments, by way of the transformation of the first measurement signals into the coordinate system of the second measurement sensor system, the first and second measurement signals can be compared to one another. In other words, the first and second measurement signals are redundant to one another and, in the event of deviations of the first and second measurement signals from one another beyond a tolerance threshold, it can be established, for example, that the measurement signals are erroneous and therefore no longer can be used for a vehicle control system. Accordingly, they and variables derived therefrom such as the relative orientation are discarded.

Furthermore, in some embodiments, for example, in the event of permanent deviations of the first and second measurement signals from one another, these deviations can be compensated for (for example, by long-term filters). In some embodiments, the deviations of the first and second measurement signals from one another are also compared to other available model variables, which are known in the vehicle control system of the vehicle, for example, to improve the reliability and the quality of the measurement signals and therefore also the quality and reliability of a vehicle control system. In some embodiments, the measurement signals are calibrated by an analysis of the deviations, to thus decrease the deviations of the first and second measurement signals from one another.

In some embodiments, for example, the signal curve of the first and/or second measurement signals or of the relative angle values is analyzed. Thus, for example, a sinusoidal curve can signal the oscillation of a trailer. Then, for example, suitable countermeasures can be taken by the vehicle control system (deceleration of the tractor vehicle, corresponding steering in the opposite direction, warning signals, etc.) on the basis of the frequency, the amplitude, and/or the phasing of the oscillation.

In some embodiments, a comparison of the at least two relative angle values, which are determined from the movement equations, to one another is carried out in general. If the two relative angle values have a deviation from one another, which is above a threshold value, an error state is established in general.

Some embodiments relate to an installation kit, in particular a retrofitting installation kit, for a vehicle for determining a relative orientation, for example, an angle or relative angle, between a first and a second region of the vehicle, which are movable in relation to one another.

The installation kit or retrofitting installation kit can be retrofitted in this case in existing vehicles, to (subsequently) provide a corresponding angle measured value, such as the wheel steering angle value or the like. In some embodiments, the installation kit or retrofitting installation kit is already installed in the vehicle, for example, in the frame of original equipment, during the production of the vehicle, in others it is only installed after manufacturing of the vehicle. The installation can also be performed in some embodiments to assist and improve a measurement precision of a system, which determines a relative orientation between two vehicle regions and ascertains a wheel steering angle, for example, or is added as a redundancy to an already existing system, for example, to determine a wheel steering angle redundantly and thus be able to recognize errors or be able to increase the measurement precision.

The installation kit comprises a first inertial measurement sensor system to be arranged in the first region of the vehicle, which is designed to output first measurement signals, which correspond to at least one acceleration component in three-dimensional space and/or at least one rotation rate component of the first inertial measurement system in the first region in three-dimensional space, wherein the first inertial measurement sensor system is attachable in the first region of the vehicle so that it does not execute a relative movement in relation to the vehicle.

In addition, the installation set has a second measurement sensor system to be arranged in the second region of the vehicle, wherein the second region is movable in relation to the first region, wherein the second inertial measurement sensor system is designed to output second measurement signals, which correspond to at least one acceleration component in three-dimensional space and/or at least one rotation rate component of the second inertial measurement sensor system in the second region of the vehicle in three-dimensional space, wherein the second inertial measurement sensor system is attachable in the second region of the vehicle so that it does not execute a relative movement in relation to the second region of the vehicle.

An analysis unit analyzes the signals of the first and second inertial measurement sensor systems and determines a relative orientation, in particular one or more relative angles, between the first and the second inertial measurement sensor systems, for example, with the aid of the above-described method steps.

In some embodiments, the installation kit is designed, for example, for a steering system of a vehicle. The first inertial measurement sensor system is designed, for example, to be attached (fixedly) on the vehicle body of the vehicle so that it cannot execute a relative movement in relation to the vehicle or the vehicle body of the vehicle. The second inertial measurement sensor system is attachable in a region of the steering system, for example, and the analysis unit ascertains a steering angle of the vehicle, as was described above. The second measurement sensor system is attachable, for example, to a steering wheel or to a steering column of the steering system.

In some embodiments, the installation kit is designed for a vehicle, which has a tractor vehicle and a trailer. The first measurement sensor system is then attachable in the tractor vehicle and the second inertial measurement sensor system is attachable to the trailer. The analysis unit ascertains a bending angle between tractor vehicle and trailer. In this case, for example, in the event of excessively strong bending angles or high oscillation amplitude or strong variation of the bending angle, a warning signal can be output or a control intervention can be triggered by a control system of the vehicle.

In some embodiments, the second inertial measurement sensor system is attachable to a wheel of the vehicle and the analysis unit ascertains a toe angle and/or camber angle. The toe angle describes the angle between the longitudinal axis of the vehicle projected on the roadway and the intersection line between wheel center plane and roadway plane. The camber angle describes the inclination of a wheel, i.e., the deviation from the vertical wheel position. This is helpful during the vehicle development, for example.

In some embodiments, the installation kit is designed for an articulated vehicle having a first and a second vehicle part. The first inertial measurement sensor system is attachable in the first vehicle part and the second inertial measurement system is attachable in the second vehicle part. The analysis unit ascertains a bending angle between the first and the second vehicle parts. In the event of an excessively strong bending angle, a warning signal can be generated or a control intervention of the control system of the vehicle can also be triggered here.

In some embodiments, the above-described installation kit is provided for a vehicle, in which a (3D/6D) measurement sensor system is already present. In the case of such embodiments, there are embodiments in which the installation kit accordingly only comprises one measurement sensor system, for example, the first or the second as described above, which is arranged in the first or second region, respectively, of the vehicle. In such embodiments, then, for example, a higher-order, already existing vehicle control system (for example, as described hereafter) is updated so that it can at least partially execute the above-described method for determining the driving state of the vehicle, wherein it uses the measurement signals provided by the measurement sensor system already present in the vehicle and the measurement signals provided by the measurement sensor system of the installation kit.

Some embodiments relate to a vehicle control system for a vehicle. The vehicle control system is designed in some embodiments to control the vehicle dynamics of the vehicle. The vehicle control system has a first inertial measurement sensor system to be arranged in the first region of the vehicle, which is designed to output first measurement signals, which correspond to at least one acceleration component in three-dimensional space and/or at least one rotation rate component of the first inertial measurement sensor system in the first region of the vehicle in three-dimensional space, wherein the first inertial measurement sensor system is attachable in the first region of the vehicle so that it does not execute a relative movement in relation to the first region of the vehicle.

A second inertial measurement sensor system is designed to be arranged in the second region of the vehicle, wherein the second region is movable in relation to the first region. The second inertial measurement sensor system is furthermore designed to output second measurement signals, which correspond to at least one acceleration component in three-dimensional space and/or a rotation rate component of the second inertial measurement system in the second region of the vehicle in three-dimensional space, wherein the second inertial measurement sensor system is attachable in the second region of the vehicle so that it does not execute a relative movement in relation to the second region of the vehicle.

In addition, the vehicle control system has a controller, which is designed to analyze the signals of the first and second inertial measurement sensor systems and to determine a relative orientation between the first and the second inertial measurement sensor systems, as was also already described above.

In some embodiments, the vehicle control system is designed to execute one or more of the above-described method steps.

As already mentioned several times above, the vehicle control system uses the determined relative orientation to stabilize the vehicle, for example, by steering in the opposite direction appropriately in the event of understeering or oversteering, etc.

In some embodiments, as were described above, it is the goal to establish the associated movement equation system for each inertial measurement sensor system.

The movement variables, i.e., the accelerations and rotation rates, are measured in some embodiments with the aid of known sensors. For example, by means of transverse acceleration sensors, which are based on the principle of a bending bar coupled to a capacitor, while yaw rate sensors utilize the Coriolis effect, for example, to measure the rotational movement.

In the present description, the term sensor is understood in the functional meaning, i.e., as a measuring unit which can measure a movement variable, i.e., for example, a rotation rate or an acceleration, along one direction in space. In some embodiments, the sensors used in the measurement sensor system can therefore be implemented as individual sensor elements, which each have a separate housing, activation, etc.

In other embodiments, these sensors are implemented in a so-called sensor cluster, which combines some or all sensors of the device in one unit, i.e., the individual sensor elements are, for example, housed in one housing and can therefore also be installed and removed jointly. For example, such a sensor cluster could have, as rotation rate sensors, yaw rate, roll rate, and pitch rate sensors, and, as acceleration sensors, transverse acceleration sensors, vertical acceleration sensors, and longitudinal acceleration sensors. For the yaw rate, in this case the transverse acceleration, which results in the “yawing” of the vehicle, is measured. For the roll rate, i.e., the rotation of the vehicle about its longitudinal axis, the vertical acceleration is measured, and for the rotation about the transverse axis, i.e., the “pitching”, the longitudinal acceleration is measured.

In some embodiments, the first and/or the second inertial measurement sensor system has a total of six sensors, namely three rotation rate sensors, and specifically one yaw rate sensor, one roll rate sensor, and one pitch rate sensor, and additionally three acceleration sensors, namely one longitudinal acceleration sensor, one transverse acceleration sensor, and one vertical acceleration sensor. The combination of these sensors is also referred to as a whole as an inertial sensor system or inertial measurement sensor system in some embodiments, whereby the complete registration of the acceleration and rotation rate values in one inertial system of the vehicle is expressed. In general, in the embodiments, the three or six sensors can also be oriented or arranged arbitrarily. In this case, the individual measured values are then converted to arbitrary predefined points and predefined orientations in three-dimensional space, for example, by means of transformation, as was also already described above.

With the aid of the accelerations in three-dimensional space and the rotation rates of the vehicle in three-dimensional space, the movement state of the vehicle or the region of the vehicle in which the respective measurement system is arranged can be (completely) determined.

In some embodiments, by detecting the first and second measurement signals over a specific period of time, and therefore, for example, the acceleration values and rotation rate values in three-dimensional space of the vehicle, a six-dimensional description of the movement state of the respective regions in which the measurement sensor system is arranged is available at a specific point in time. A corresponding (six-dimensional) movement equation system may be derived therefrom, which comprises the three-dimensional components of the acceleration and the three-dimensional components of the rotation rate of the respective region of the vehicle.

In some embodiments, the individual measured points, i.e., the first and second measurement signals obtained over the time, which are based on respective sensor signals, which correspond to the three-dimensional acceleration of the vehicle region or the three-dimensional rotation rate of the vehicle region, are now integrated, for example, added up. In this manner, the “six-dimensional” movement equation system can be solved by the integration. A three-dimensional (vehicle) velocity (by integration of the acceleration values) and a three-dimensional orientation of the vehicle (by integration of the rotation rates) in space can thus be ascertained as vehicle state variables.

In some embodiments, chips are used, which contain three-axis acceleration sensors and rotation rate sensors. Such chips are available cost-effectively

In some embodiments, however, measurement sensor systems are also used, which have a lesser sensor scope (for example, those which only measure accelerations or only rotation rates or, for example, only have a 2-D or 1D sensor system). However, the redundancy is thus decreased in some embodiments. If the sensor scope becomes excessively small, it is possible that the redundancy will be completely lost.

In some embodiments, not all movement equations are always usable. For example, if all three rotation rates are equal to 0, the equation system of the rotation rates then cannot provide any results. The rotation rates (alone) only enable a determination of the steering angle values when the vehicle rotates. Therefore, in some embodiments the redundancy and quality of the results are not only dependent on the available sensor system, but rather also on the vehicle movement.

The measurement signals of the measurement sensor systems can be transmitted in a known manner to the analysis unit or controller. In some embodiments, they are fed into the vehicle bus, in others they are transmitted via separate lines. In some embodiments, the measurement signals can also be transmitted via radio, for example, if a measurement sensor system is attached to a wheel, steering wheel, or a rear vehicle part (trailer, rear bus part in an articulated bus, or the like) and thus laying a cable to the controller is difficult and/or complex.

As already indicated above, in some embodiments, an angle, in particular a wheel steering angle, which can be used as a redundant value, for example, can be ascertained from the relative orientation. Thus, for example, in some embodiments, the above-described installation kit is provided for the purpose of equipping a vehicle to determine an angle value, in particular a wheel steering angle value, redundantly. In such vehicles, a system for the (wheel steering) angle determination is already provided and the installation kit is designed to also determine this already provided angle. It is thus possible to determine the angle more precisely and/or to provide an error check by comparing the angle values of the existing system to those of the installation kit.

Accordingly, some embodiments relate to an installation kit for a vehicle or a method for redundant determination of a relative orientation between a first and a second region of the vehicle, which are movable in relation to one another, wherein the vehicle is already designed to determine a corresponding relative orientation. The installation kit corresponds in this case essentially to the already above-described embodiments and comprises a first inertial measurement system to be arranged in the first region of the vehicle, which is designed to output first measurement signals, which correspond to at least one acceleration component in three-dimensional space and/or at least one rotation rate component of the first inertial measurement system in the first region of the vehicle in three-dimensional space, wherein the first inertial measurement sensor system is attachable in the first region of the vehicle so that it does not execute a relative movement in relation to the first region of the vehicle. It comprises a second inertial measurement sensor system to be arranged in the second region of the vehicle, wherein the second region is movable in relation to the first, wherein the second inertial measurement sensor system is designed to output second measurement signals, which correspond to at least one acceleration component in three-dimensional space and/or at least one rotation rate component of the second inertial measurement sensor system in the second region of the vehicle in three-dimensional space, wherein the second inertial measurement sensor system is attachable in the second region of the vehicle so that it does not execute a relative movement in relation to the second region of the vehicle. In addition, it comprises an analysis unit, which analyzes the signals of the first and second inertial measurement sensor systems and determines a relative orientation between the first and the second inertial measurement sensor systems. An angle value, which is compared to an angle value ascertained in the vehicle by an already existing system, is ascertained from the relative orientation.

The comparison of the angle values can be performed in this case in the installation kit or in other embodiments in a central controller of the vehicle, which is programmed accordingly. It can be established from the comparison, for example, upon the presence of a difference greater than a predetermined threshold value, that the wheel steering angle determination is erroneous. In addition, the measurement precision can be improved by means of the redundant angle value determination. Furthermore, for example, in the event of failure or imperfection of the already existing system, the vehicle can be controlled further on the basis of the angle value or angle values provided by the installation kit.

The above-described methods and devices are also designed in some embodiments for the ascertainment of the following relative orientations of vehicle parts: gas pedal position, clutch pedal position, brake pedal position, shift lever position, arbitrary lever position (for example, light lever, windshield wiper lever, turn signal lever, etc.), and arbitrary rocker switch positions. For this purpose, as described above, a measurement sensor system is fastened, for example, on the region of which the orientation is to be determined (gas pedal, clutch pedal, etc., as listed), while the second measurement sensor system is bound to the vehicle, for example, in that it is fastened on the vehicle body.

In some embodiments, the installation kit (or retrofitting installation kit) is also designed modularly. A first module has the first inertial measurement sensor system and a second module has the second inertial measurement sensor system and the analysis unit. Both the first and also the second modules are designed to communicate with one another via a bus system, for example, a CAN bus of a vehicle. The first or second module has for this purpose a matching interface for communication with the associated bus system. For example, the first and second modules have a CAN bus interface to be able to communicate with and via the CAN bus. In some embodiments, the installation kit also comprises multiple second modules. The second module is capable of being attached at arbitrary positions in the vehicle on moving elements (for example, on various vehicle pedals, levers, and switches, as mentioned above). It receives the measurement signals of the first measurement sensor system via the bus system and can then independently determine the relative orientation, as described above, by means of the analysis unit and the measurement signals of the second measurement sensor system. The first module is typically arranged bound to the vehicle in this case (for example, fastened on the vehicle body). After the second module has determined the respective relative orientation or a variable derived therefrom, the second module transmits this result to the CAN bus and, for example, to a central vehicle control system (ESP control unit or the like).

In some embodiments, a first module is not required, but rather the measurement signals of the 6D sensor system are used, which are associated with an ESP control unit intrinsic to the vehicle, for example. In this case, the second module also receives the first measurement signals via the bus system, which originate in this case from the ESP control unit, for example, and calculates, together with those of the second measurement sensor system, the relative orientation and transmits the result via the CAN bus to a central vehicle control system.

The first and/or second module is dimensioned sufficiently small in some embodiments so that it can also be attached to corresponding regions of the vehicle which have little space for the module, for example, switches, pedals, levers, and the like.

Returning to FIG. 1, an embodiment is shown therein, in which a steering angle is ascertained according to the above-explained method. A first inertial measurement sensor system 1 is arranged fixedly in relation to the main axis 14 of a vehicle 10, so that it cannot execute a relative movement in relation to the main axis 14 of the vehicle.

A second inertial measurement sensor system 2 is arranged on a steering column 11 of the vehicle 10. The steering column and 11 is connected to a front axle 12 of the vehicle. The second inertial measurement sensor system 2 is arranged on the steering column 11 so that it cannot execute a relative movement in relation to the steering column 11.

The first measurement sensor system 1 forms an inertial system with the orthogonal coordinate axes X, Y, and Z. This is also true for the second inertial measurement sensor system 2 on the steering column 11, which forms a second inertial system with the orthogonal coordinate axes x, y, and z.

The steering column 11 forms an angle α in relation to the main axis 14 of the vehicle. In addition, the second inertial measurement sensor system 2 can be pivoted by a steering movement about the wheel steering angle or steering angle δ to be determined. As mentioned above, the wheel steering angle can be calculated easily, for example, via a characteristic curve from the steering angle, so that a strict differentiation is not made hereafter between the steering angle and the wheel steering angle ascertained therefrom.

Each measurement sensor system is constructed as a 6D sensor system and comprises an acceleration sensor and a rotation rate sensor, which respectively determines the three-dimensional acceleration and the three-dimensional rotation rate at the location at which it is arranged. This means the measurement sensor system 1 determines the three-dimensional acceleration of the vehicle 10 on the main axis 14 and the measurement sensor system 2 determines the three-dimensional acceleration of the steering column 11 of the vehicle 10.

The three acceleration components at the position of the measurement sensor system 2 in the vehicle-bound coordinate system can be determined as a function of the corresponding values of the measurement sensor system 1 by means of transformation. The rotation rates at position 2 in the vehicle-bound coordinate system are identical to those at position 1, if the orientation of the coordinate system remains the same. If another orientation of the coordinate system is selected, both the acceleration values and also the rotation rate values must be transformed.

As already explained above, the three acceleration components at one position, here at the position of the measurement sensor system 1, are converted or transformed into the position of the other measurement sensor system, the position of the measurement sensor system 2 here. Before this transformation, in some embodiments firstly a transformation of the acceleration components of the first measurement sensor system at the first position to the first position is performed and/or a transformation of the acceleration components of the second measurement sensor system at the second position to the second position is performed, as also explained above. In some exemplary embodiments, however, the three acceleration sensors of the measurement sensor system are designed to be physically so small that they are arranged more or less at the same location and therefore such a transformation of the acceleration signals at the location of the measurement sensor system is not necessary, but rather only the transformation of the acceleration values of one measurement sensor system into the coordinate system of the other measurement sensor system.

If the measured values of the inertial system 1 or 2 are identified as follows:

accelerations in 1: [a_{X1}, a_{Y1}, a_{Z1}]
rotation rates in 1: [r_{X1}, r_{Y1}, r_{Z1}]
accelerations in 2: [a_{X2}, a_{Y2}, a_{Z2}]
rotation rates in 2: [r_{X2}, r_{Y2}, r_{Z2}]
it follows that:

a_{X2}=a_{X1}+(r_{Y1}²+r_{Z1}²)*L+H*dr_{Y1}/dt−B*dr_{Z1}/dt

a_{Y2}=a_{Y1}+(r_{X1}²+r_{Z1}²)*L+L*dr_{Z1}/dt−H*dr_{X1}/dt

a_{Z2}=a_{Z1}+(r_{X1}²+r_{Y1}²)*L+B*dr_{X1}/dt−L*dr_{Y1}/dt

r_{X2}=r_{X1}

r_{Y2}=r_{Y1}

r_{Z2}=r_{Z1}

wherein the variables L, B, and H are defined as shown in FIG. 1.

The measurement sensor system 2, which is bound to the steering wheel or steering column, provides accelerations and rotation rates in the xyz coordinate system: [aₓ₂, a_{y2}, a_{z2}] for the accelerations [rₓ₂, r_{y2}, r_{z2}] for the rotation rates.

The conversion of the values of the XYZ coordinate system at the position of the measurement sensor system 1 to the xyz coordinate system at the position of the measurement sensor system 2 is performed by means of the following transformation:

$$\begin{matrix}[ {a}_{x 2} ] & & [ \begin{matrix}cos ( α ) & 0 & - sin ( α )\end{matrix} ] [ \begin{matrix}1 & 0 & 0\end{matrix} ] [ {a}_{x 2} ] \\ [ {a}_{y 2} ] & = & [ \begin{matrix}0 & 1 & 0\end{matrix} ] * [ \begin{matrix}0 & cos ( δ ) & + sin ( δ )\end{matrix} ] * [ {a}_{y 2} ] \\ [ {a}_{z 2} ] & & [ \begin{matrix}sin ( α ) & 0 & cos ( α )\end{matrix} ] [ \begin{matrix}0 & - sin ( δ ) & 0\end{matrix} ] [ {a}_{z 2} ]\end{matrix}$$

$$\begin{matrix}[ {r}_{x 2} ] & & [ \begin{matrix}cos ( α ) & 0 & - sin ( α )\end{matrix} ] [ \begin{matrix}1 & 0 & 0\end{matrix} ] [ {r}_{x 2} ] \\ [ {r}_{y 2} ] & = & [ \begin{matrix}0 & 1 & 0\end{matrix} ] * [ \begin{matrix}0 & cos ( δ ) & + sin ( δ )\end{matrix} ] * [ {r}_{y 2} ] \\ [ {r}_{z 2} ] & & [ \begin{matrix}sin ( α ) & 0 & cos ( α )\end{matrix} ] [ \begin{matrix}0 & - sin ( δ ) & 0\end{matrix} ] [ {r}_{z 2} ]\end{matrix}$$

Depending on whether or not the vehicle is currently moving with rotation rates, more or fewer equations are accordingly available for determining the steering angle δ, as was also already described above.

To check whether the determination of the steering angle δ is correct, in some embodiments the inclination of the steering column, i.e., the steering column angle α can additionally also be determined. By way of the comparison of the ascertained steering column angle α and the steering column angle known from the vehicle design, a deviation can be established, from which an error can be concluded, for example, if the ascertained steering column angle is a right angle and the steering column would accordingly protrude straight upward.

Because acceleration signals can have certain noise levels, the unfiltered result of the steering angle can be noisy. By means of filtering, the signal quality can be improved in some embodiments at the cost of the phasing. The phase offset can be corrected, because the rotation rate measured values provide the steering velocity for correction.

In other embodiments, the correction is performed via Kalman filters or other filter methods known to a person skilled in the art.

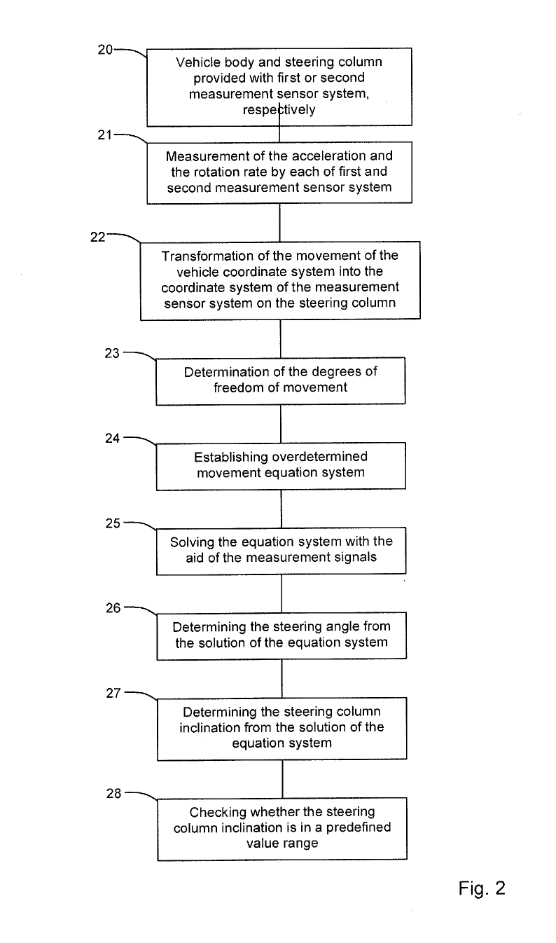

FIG. 2 shows a sequence of a method for the above-described embodiment. Firstly, the vehicle is provided with a first and second measurement sensor system, as described above, on the vehicle body or on the steering column, respectively, step 20. The measurement sensor system on the vehicle body is fixedly connected and cannot execute a relative movement in relation to the vehicle body. The second measurement sensor system is fixed on the steering column and rotates with the steering movement.

The two measurement sensor systems then measure the accelerations and the rotation rates which act thereon, step 21.

Next, the movement which is detected by the measurement sensor system on the vehicle body, for example, is transformed into the coordinate system of the measurement sensor system on the steering column, step 22.

In addition, the number of degrees of freedom of movement is determined, step 23. In the case of a steering column, which is not adjustable in the inclination, there is only one degree of freedom, the rotation about an angle 8.

Furthermore, the movement equation system—which is overdetermined in this case—is established, wherein the number of degrees of freedom of movement is also considered in this case, step 24.

The movement equation system is solved in a step 25 by means of the measurement signals of the first and second measurement sensor systems detected in step 21.

The steering angle δ is ascertained from the solution of the movement equation system, step 26, and the steering column inclination is ascertained, step 27.

The ascertained steering column inclination is checked for plausibility, in that, for example, it is checked whether it is in a predefined value range, in which the steering column inclination can be as a result of the design, step 28.

If the steering column inclination is outside the value range, the measured values and the results are discarded and the method begins from the start.

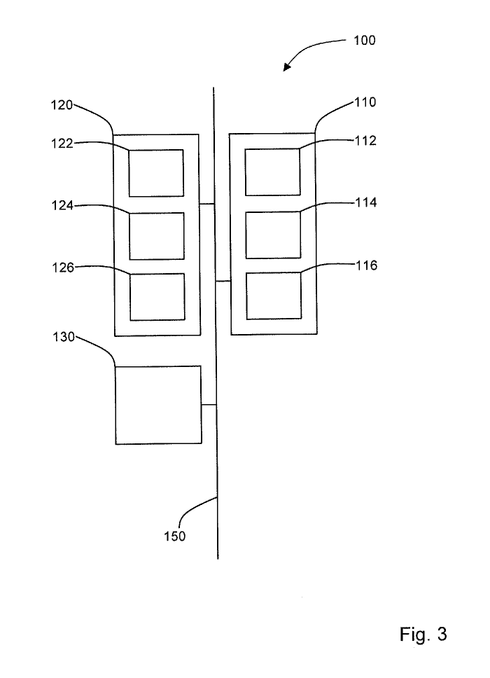

FIG. 3 schematically shows an embodiment of a measurement sensor system 100 for the complete determination of the movement state of a vehicle region, for example, the vehicle itself or the steering column, as is also used in the above-described embodiments.

The measurement sensor system 100 comprises an acceleration sensor 110 and a rotation rate sensor 120, which together form an inertial sensor system. The acceleration sensor 110 contains a longitudinal acceleration sensor 112, a transverse acceleration sensor 114, and a vertical acceleration sensor 116, which each output a signal which is representative for the transverse acceleration, longitudinal acceleration, or vertical acceleration, respectively, of the vehicle. Therefore, the signals describe the acceleration of the vehicle or the vehicle region in which the measurement sensor system is arranged in three-dimensional space. The signals are provided by the acceleration sensor on a signal line 150, so that they can be processed by a microprocessor 130. The rotation rate sensor contains a pitch rate sensor 122, a roll rate sensor 124, and a yaw rate sensor 126, which each output a signal which is representative for the pitch rate, roll rate, or yaw rate, respectively, of the vehicle. The signals therefore describe the rotation rate of the vehicle or the vehicle region in three-dimensional space. The rotation rate sensor 120 also provides the signals on the signal line 150.

The microprocessor finally processes the signals as was already described above and as occurs, for example, in the embodiment according to FIGS. 1 and 2.

In embodiments having extreme quality requirements for the vehicle state determination (for example, instantaneous error recognition), a further sensor can additionally be provided for a rotation rate and/or acceleration, which enables a redundancy with which each error of an arbitrary sensor is recognized.

In some embodiments, the sensors 110, 120, 130 of the measurement sensor system 100 or the sensors of the inertial sensor system are installed nearly at a single location or close to one another. In embodiments in which the sensors are installed further apart from one another because of special boundary conditions, all signals are transformed based on the available rotation rates in space so that they relate to a shared position.

In some embodiments, the above-described methods or embodiments are contained in a vehicle control system or a (retrofitting) installation kit, as was also already explained above.

1. A method for determining the driving state of a vehicle, wherein the method comprises the following steps:
detecting (21) first measurement signals of a first inertial measurement sensor system (1, 100), wherein the first inertial measurement sensor system is arranged in a first region of the vehicle so that it does not execute a relative movement in relation to the first region of the vehicle, and wherein the first measurement signals correspond to at least one acceleration component in three-dimensional space and/or at least one rotation rate component of the first inertial measurement sensor system (1, 100) in the first region of the vehicle in three-dimensional space;
detecting (21) second measurement signals of a second inertial measurement sensor system (2, 100), wherein the second inertial measurement sensor system is arranged in a second region of the vehicle, which is movable in relation to the first region of the vehicle, wherein it is arranged so that it does not execute a relative movement in relation to the second region of the vehicle, and wherein the second measurement signals correspond to at least one acceleration component in three-dimensional space and/or at least one rotation rate component of the second inertial measurement system (2, 100) in the second region of the vehicle in three-dimensional space;
analyzing (22, 23, 24, 25) the first and second measurement signals based on the functional relationship between the movement of the first inertial measurement system and the movement of the second inertial measurement sensor system; and
based on the result of the analysis of the first and second measurement signals, determining (26) the relative orientation of the two inertial measurement sensor systems to one another.

2. The method according to claim 1, wherein the first measurement signals correspond to the three-dimensional acceleration and/or the three-dimensional rotation rate of the first measurement sensor system (1, 100) in the first region of the vehicle and/or the second measurement signals correspond to the three-dimensional acceleration and/or the three-dimensional rotation rate of the second measurement sensor system (2, 100) in the second region of the vehicle.

3. The method according to any one of the preceding claims, wherein a relative angle, in particular a wheel steering angle (δ), is determined from the orientation.

4. The method according to any one of the preceding claims, wherein the step of analyzing the first and second measurement signals comprises a transformation (22) of the movement of the first inertial measurement sensor system into the coordinate system of the second inertial measurement sensor system.

5. The method according to any one of the preceding claims, wherein the step of analyzing the first and second measurement signals comprises establishing (24) a movement equation system for the movement of the first inertial measurement sensor system and the movement of the second inertial measurement sensor system.

6. The method according to claim 5, wherein the movement equation system is overdetermined.

7. The method according to claim 6, wherein the second region of the vehicle only has one degree of freedom of movement and the step of determining the relative orientation comprises the determination of at least two relative angles.

8. The method according to claim 7, furthermore comprising the following steps:
comparing the at least two relative angle values to one another; and
establishing an error state if the two relative angle values have a deviation from one another which is greater than a threshold value.

9. An installation kit for a vehicle for determining a relative orientation between a first and a second region of the vehicle, which are movable in relation to one another, comprising:
a first inertial measurement system (1, 100) to be arranged in the first region of the vehicle, which is designed to output first measurement signals, which correspond to at least one acceleration component in three-dimensional space and/or at least one rotation rate component of the first inertial measurement sensor system (1, 100) in the first region of the vehicle in three-dimensional space, wherein the first inertial measurement sensor system (1, 100) is attachable in the first region of the vehicle so that it does not execute a relative movement in relation to the first region of the vehicle;
a second inertial measurement sensor system (2, 100) to be arranged in the second region of the vehicle, wherein the second region is movable in relation to the first region, wherein the second inertial measurement sensor system is designed to output second measurement signals, which correspond to at least one acceleration component in three-dimensional space and/or at least one rotation rate component of the second inertial measurement sensor system (2, 100) in the second region of the vehicle in three-dimensional space, wherein the second inertial measurement sensor system (2, 100) is attachable in the second region of the vehicle so that it does not execute a relative movement in relation to the second region of the vehicle; and
an analysis unit (130), which analyzes the signals of the first (1, 100) and second (2, 100) inertial measurement sensor systems and determines a relative orientation between the first and the second inertial measurement sensor systems.

10. The installation kit according to claim 9, wherein the analysis unit (130) is designed to execute the method according to any one of claims 1 to 8.

11. The installation kit according to in any one of claims 9 or 10, wherein the vehicle has a steering system and the second inertial measurement sensor system (2, 100) is attachable in a region of the steering system and the analysis unit ascertains a steering angle of the vehicle.

12. The installation kit according to any one of claim 9 or 10, wherein the vehicle has a tractor vehicle and a trailer and the second inertial measurement sensor system is attachable to the trailer and the analysis unit ascertains a bending angle between tractor vehicle and trailer.

13. The installation kit according to any one of claim 9 or 10, wherein the second inertial measurement sensor system is attachable to a wheel of the vehicle and the analysis unit (130) ascertains a toe angle and/or camber angle.

14. The installation kit according to any one of claim 9 or 10, wherein the vehicle is an articulated vehicle having a first and a second vehicle part and the first inertial measurement sensor system is attachable in the first vehicle part and the second inertial measurement sensor system is attachable in the second vehicle part and the analysis unit (130) ascertains a bending angle between the first and the second vehicle parts.

15. The installation kit according to any one of claims 9 to 14, which furthermore comprises at least one first module, which has the first inertial measurement sensor system (1, 100), and comprises one second module, which has the second inertial measurement sensor system (1, 100) and the analysis unit (130), wherein both the first and also the second module are designed to communicate with one another via a bus system.

16. A vehicle control system, comprising:
a first inertial measurement system (1, 100) to be arranged in the first region of the vehicle, which is designed to output first measurement signals, which correspond to at least one acceleration component in three-dimensional space and/or at least one rotation rate component of the first inertial measurement sensor system (1, 100) in the first region of the vehicle in three-dimensional space, wherein the first inertial measurement sensor system (1, 100) is attachable in the first region of the vehicle so that it does not execute a relative movement in relation to the first region of the vehicle;
a second inertial measurement sensor system (2, 100) to be arranged in the second region of the vehicle, wherein the second region is movable in relation to the first region, wherein the second inertial measurement sensor system is designed to output second measurement signals, which correspond to at least one acceleration component in three-dimensional space and/or at least one rotation rate component of the second inertial measurement sensor system (2, 100) in the second region of the vehicle in three-dimensional space, wherein the second inertial measurement sensor system (2, 100) is attachable in the second region of the vehicle so that it does not execute a relative movement in relation to the second region of the vehicle; and
a controller (130), which is designed to analyze the signals of the first and second inertial measurement sensor systems and to determine a relative orientation between the first and the second inertial measurement sensor systems.

17. The vehicle control system according to claim 16, wherein the controller is designed to execute the method according to any one of claims 1 to 8.
